(19) United States
(12) Patent Application Publication
(10) Pub. No.: US 2008/0054036 A1
(43) Pub. Date: Mar. 6, 2008

(54) Apparatus for securing a surf board in a truckbed

(76) Inventors: Donald S. Egigian, San Clemente, CA (US); Steve Goebel, Laguna Beach, CA (US)

Correspondence Address: PATENT LAW & VENTURE GROUP, 2424 S.E. BRISTOL, SUITE 300, NEWPORT BEACH, CA, 92660, US

(21) Appl. No.: 11/515,332

(22) Filed: Aug. 31, 2006

(51) Int. Cl. B60R 9/00; B60R 7/00

(52) U.S. Cl. 224/403

(57) ABSTRACT

A surfboard is secured within a truck bed allowing ease of insertion and removal. A Z-shaped bar defines a proximal bar portion, a medial bar portion and a distal bar portion. A clamp is engaged with the proximal bar portion. A compliant sleeve covers the distal bar portion, and an elastic cord formed with loops at opposing ends is stretched over the distal bar portion. The clamp is fastened to a side flange of the truck bed and the distal portion is positioned on top of the tailgate so that a surfboard placed into the truck bed rests at one end on the bed of the truck and is held between the sleeve and the cord at the other end while resting on the sleeve. The cord safely clamps the surfboard in place.

### BACKGROUND OF THE INVENTION

1. Field of the Present Disclosure

This disclosure relates generally to BROAD STATEMENT

2. Description of Related Art Including Information Disclosed Under 37 CFR 1.97 and 1.98

Snyder, U.S. Pat. No. 6,942,532, discloses a removable snap-on plastic device can be affixed to a surfboard leash allowing the open outer sleeve portion to clamp onto any adjacent section of the leash to prevent it from unraveling, representing significant improvements over other similar devices. This device does not interfere with the performance of a surfer nor affect the performance of the surfboard leash.

Wroble, U.S. Pat. No. 5,706,680, discloses locking devices for surfboards, sailboards and skateboards which clamp about tapered sides of surfboards and sailboards adjacent the fins. The devices clamp about skateboard sides between the two sets of wheels. One version has a hook ended rod that grips about a board side and another end that attaches by a padlock to a second rod which hooks about another board side. The first rod end has through holes that insert into a cylinder end of the second rod. The further one rod is inserted into the second cylindrical rod end, the closer the spacing between the hooks. A padlock in the through-holes connect the rods. Another version has a padlock in the second cylindrical rod where grooves on the first rod end are locked in place. Another version has a perpendicular extension bracket that wraps about one surfboard or sailboard fin. Another version uses a top flat plate that hingedly connects to a curved bottom plate. Opposite ends of the plates have matching through-holes for a padlock. Another version has side-by-side holes in both plates to accommodate different board widths. A cable connects the devices to a pole or bikerack.

Bolich, U.S. Pat. No. 5,582,044, discloses a method of locking a surfboard to a roof rack crossbar using a series of adjustable mount block assemblies (10a-b) affixed to the rack crossbars (13) at a lateral position of contact with the sides of a surfboard (15a-b) placed horizontally on top of the crossbars. The mount block assemblies utilize a metal clamp (12) that is vertically adjusted to the thickness of the surfboard at the lateral position of contact. An internal axle (14) connects two side cams (10b) vertically adjacent to a center mount block (10a) with clamp (12) affixed within the side cams. Axle (14) allows for the clamp assemblies to open and close by means of rotation of the side cams relative to the position of the mount block. The mount block assemblies utilize a lock pin (16a-b) that inserts through an alignment of holes in the mount block assembly to a position of engagement with a cam lock assembly (22a-f). Utility of the cam lock serves to prevent or allow removal of the lock pin. This clamping method prevents movement of a surfboard on the crossbar and deters theft.

Wilson, U.S. Pat. No. 5,340,003, a bicycle carrier rack adapter comprising a bracket member having a first arm, a second arm and a connecting element joining the first and second arms. At least one aperture is provided in each arm and the connecting element. A fastening member is detachably secured to the connecting element by fasteners. A pair of adjustable clamp members including a first and a second aperture are configured to receive and secure a fastening element allowing attachment of either the first and second arm of the bracket member. A coupling member for securing a bicycle carrier rack to the bracket member is also provided. The coupling member includes a pair of legs and a joining member and is adapted to be received and secured within the apertures of the adjustable clamp members, allowing for easy and convenient attachment of a wide variety of bicycle accessories such as child carriers, cargo carriers, surfboard racks, golf club bag carriers, and the like to a standard bicycle rack.

The related art described above discloses various attachment devices for securing a surfboard and its accoutrements. However, the prior art fails to disclose a device for securing a surfboard within the bed of a truck so as to prevent damage to the truck bed or the surfboard. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

When carrying a surfboard in the bed of a truck, inertial forces on the surfboard due to acceleration and braking of the truck causes the surfboard to move about the truck bed causing it to become scratched or damaged. Therefore, surfboards are tied down or otherwise secured against movement so as to avoid this problem when transporting them. However, your applicants have found that the prior art does not teach a securement solution that is easy to install and remove from a truck bed, and which fastens a surfboard in place by quickly inserting the board between holding members that are able to accommodate various size boards. Further, your applicants have not found a prior art solution that accommodates various sized trucks.

The presently described apparatus provides a solution for holding a surfboard within a truck bed with ease of insertion and removal. A Z-shaped bar defines a proximal bar portion, a medial bar portion and a distal bar portion. A clamp is engaged with the proximal bar portion. A compliant sleeve covers the distal bar portion, and an elastic cord formed with loops at opposing ends is stretched over the distal bar portion. The clamp is fastened to a side flange of the truck bed and the distal portion is positioned on top of the tailgate so that a surfboard placed into the truck bed rests at one end on the bed of the truck and is held between the sleeve and the cord at the other end while resting on the sleeve. The cord safely clamps the surfboard in place.

A primary objective inherent in the above described apparatus and method of use is to provide advantages not taught by the prior art.

Another objective is to provide a surfboard clamping device that is quickly and easily mounted in the bed of a truck.

A further objective is to provide such a device that is able to secure a surfboard within the bed of a truck.

A still further objective is to provide such a device that is able to accommodate a range of different truck sizes and surfboard sizes.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus as mounted in a truck bed and supporting a surfboard;

FIG. 2 is a further perspective view thereof;

FIG. 3 is a further perspective view thereof; and

FIG. 4 is a front elevational view thereof showing a surfboard and a portion of a truck side panel in vertical section and showing details of the engagement of clamp and side panel.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

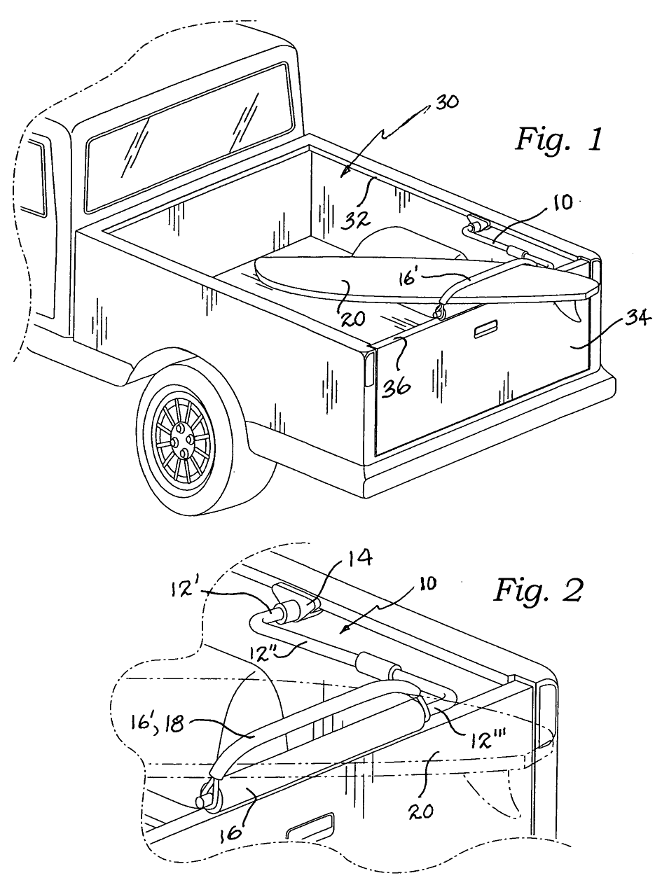

Described now in detail, and as shown in the attached figures, a surfboard securement apparatus 10 secures a surfboard 20 within a truck bed 30 against movement. The truck bed 30 provides a side flange 32, which runs along each side of the truck bed 30, as is well known in the art and best shown in FIG. 4 in cross-section. The truck bed 30 also provides a tailgate 34 which has a top tailgate surface 36 which faces upwardly when the tailgate 34 is in its closed position as shown in FIG. 1.

The apparatus 10 has a Z-shaped bar 12 preferably made of rigid tubular metal stock, with a proximal bar portion 12′, a medial bar portion 12″ and a distal bar portion 12′″ all contiguous. A clamp 14 engages the proximal bar portion 12′ and a compliant sleeve 16 covers the distal bar portion 12′″. The compliant sleeve 16 is preferably made of a soft rubber for cushioning the surfboard 20. An elastic cord 18 such as a bungee type cord is formed with loops 19 at its opposing ends. The elastic cord 18 is stretched over the distal bar portion 12′″ and it is preferably covered by a further compliant sleeve 16′ of soft rubber, albeit somewhat smaller diameter than sleeve 16 for improved resilience and cushioning as the two sleeves 16 and 16′ are in contact with the surfboard 20 and are compressed by cord 18 against the surfaces of the surfboard 20. The cord 18 is somewhat shorter then the length of sleeve 16 so that it must be stretched to place its loops 19 on distal bar portion 12′″ at opposing ends of sleeve 16. This generates the clamping force necessary to secure surfboard 20. With the clamp 14 fastened to the side flange 32 of the truck bed 30 the distal portion 12′″ is positionable on the top tailgate surface 36 for resting the surfboard 20 between the sleeve 16 and the cord 18.

To accomplish the above clamping action, the loops 19 are sized for receiving the distal bar portion 12′″ but will not receive the sleeve 16, i.e., sleeve 16 maintains the cord 18 in a stretched condition when the sleeve 16 and cord 18 are placed as shown in FIG. 4. It should be realized that fastening means other than loops may be employed and such fastening means is only limited by such fastening means that may be in the art and known to those of skill at this time.

Preferably, clamp 14 provides opposing plates 14′ spaced apart for receiving the side flange 32 therebetween. One of the opposing plates 14′ provides fasteners 14″ therein, preferably screws. The fasteners 14″ are movable for applying clamping action on the side flange 32 so as to tightly secure the clamp 14 to the side flange 32.

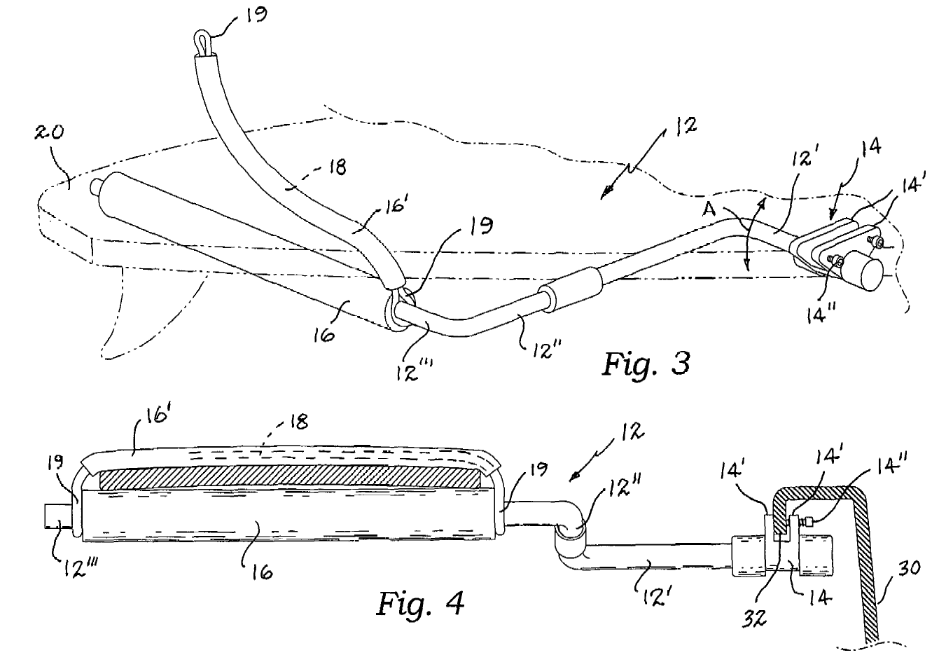

Preferably, the proximal bar portion 12′ is rotationally engaged with the clamp 14 as shown in FIG. 3 by arrow “A”. With this rotational feature and the ability to fix the clamp 14 at any position along flange 32, it is possible for the apparatus to be used with a wide range of truck sizes, i.e., tailgate heights. For a given installation, and with the truck's tailgate in the up and locked position, the apparatus is placed with the sleeve 16 in position on the top surface 36 of the tailgate and the further portions of the apparatus extending into the bed of the truck. With the sleeve 16 held in place, the clamp 14 is rotated into engagement with the flange 32, placing flange 32 between plates 14′ and then screws (fasteners 14″) are tightened so as to secure clamp 14 on flange 32. When the apparatus is not in use, it may be rotated according to arrow “A” in FIG. 3 toward the cab of the truck with the sleeve 16 resting in the bed of the truck.

In use, the apparatus 10 is positioned as shown in FIG. 2 and surfboard 20 is Placed between sleeves 16 and 16′ to secure it in place during transport. To accomplish this, the distal loop 19 of cord 18 is removed from distal bar portion 12′″ as shown in FIG. 3, and then with the surfboard 20 laid against sleeve 16, the distal loop 19 is re-engaged with portion 12′″.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A surfboard securement apparatus for holding a surfboard within a truck bed, wherein the truck bed provides a side flange and a tailgate with a top tailgate surface, the apparatus comprising: a Z-shaped bar defining a proximal bar portion, a medial bar portion and a distal bar portion; a clamp engaging the proximal bar portion; a compliant sleeve covering the distal bar portion; and an elastic cord formed with loops at opposing ends thereof, the elastic cord stretched over the distal bar portion; whereby, with the clamp fastened to the side flange of the truck bed the distal bar portion is positionable on the top tailgate surface for resting the surfboard between the sleeve and the cord.

2. The apparatus of claim 1 wherein the Z-shaped bar is constructed of rigid tube stock.

3. The apparatus of claim 1 wherein the loops are sized for receiving the distal bar portion therein and for not receiving the sleeve.

4. The apparatus of claim 1 wherein the clamp provides opposing plates spaced apart for receiving the side flange therebetween, at least one of the opposing plates providing fasteners therein, the fasteners movable for applying clamping action on the side flange securing the clamp to the side flange.

4. The apparatus of claim 1 wherein the proximal bar portion is rotationally engaged within the clamp.

5. A truck with surfboard securement apparatus comprising: a truck having a truck bed, a side flange and a tailgate, the tailgate having a top tailgate surface; and a Z-shaped bar defining a proximal bar portion, a medial bar portion and a distal bar portion; a clamp engaging the proximal bar portion; a compliant sleeve covering the distal bar portion; and an elastic cord formed with loops at opposing ends thereof, the elastic cord stretched over the distal bar portion; whereby, with the clamp fastened to the side flange of the truck bed the distal bar portion is positionable on the top tailgate surface for resting the surfboard between the sleeve and the cord.

6. The apparatus of claim 5 wherein the Z-shaped bar is constructed of rigid tube stock.

7. The apparatus of claim 5 wherein the loops are sized for receiving the distal bar portion therein and for not receiving the sleeve.

8. The apparatus of claim 5 wherein the clamp provides opposing plates spaced apart for receiving the side flange therebetween, at least one of the opposing plates providing fasteners therein, the fasteners movable for applying clamping action on the side flange securing the clamp to the side flange.

9. The apparatus of claim 5 wherein the proximal bar portion is rotationally engaged within the clamp.

10. A securement apparatus for holding an object within a truck bed, wherein the truck bed provides a side flange and a tailgate with a top tailgate surface, the apparatus comprising: a Z-shaped bar defining a proximal bar portion, a medial bar portion and a distal bar portion; a clamp engaging the proximal bar portion; a compliant sleeve covering the distal bar portion; and an elastic cord engagable at opposing ends thereof with the distal bar portion, the elastic cord stretched over the distal bar portion; the clamp fastened to the side flange of the truck bed, the distal bar portion rotationally positionable on the top tailgate surface for resting the object between the sleeve and the cord.

11. The apparatus of claim 10 wherein the Z-shaped bar is constructed of rigid tube stock.

12. The apparatus of claim 10 wherein the elastic cord provides opposing terminal loops sized for receiving the distal bar portion therein and for not receiving the sleeve therein.

13. The apparatus of claim 10 wherein the clamp provides means for removably engaging the side flange.

14. The apparatus of claim 10 wherein the proximal bar portion is rotationally engaged within the clamp.
